(19) United States
(12) Patent Application Publication
(10) Pub. No.: US 2010/0114684 A1
(43) Pub. Date: May 6, 2010

(54) CHAT ROOMS SEARCH ENGINE QUERYER

(76) Inventor: RONEL NEGED, RISHON LEZION (IL)

Correspondence Address: Ronel Neged, 3 Harimon Street, Rishon Lezion, 75202, IL

(21) Appl. No.: 12/564,055

(22) Filed: Sep. 22, 2009

Related U.S. Application Data
(60) Provisional application No. 61/099,994, filed on Sep. 25, 2008.

(51) Int. Cl. G06F 17/30; G06Q 30/00

(52) U.S. Cl. 705/14.14; 707/711; 707/755; 707/E17.002; 707/800; 707/E17.055; 707/E17.109; 707/723

(57) ABSTRACT

A system and methods that enable a user to perform real time search of chat rooms discussion information defined by one or more keywords, provide the user with a list of chat rooms that are currently discussing the information and enable the user to selectively join the discussion in a particular chat room. An aspect of the present invention is to provide a link to each chat room, and thereby enable a user to enter the chat room without having to login. Another aspect of the present invention is to enable a user to submit a query directly from the search engine to a particular participant of a particular chat room. According to such variation of the present invention, the user can chat with a particular participant of a particular chat room, without having to log into that chat room. Optionally, a user can be self registered as a relevant user.

### RELATED APPLICATION

The present application claims the benefit under 35 U.S.C. 119(e) of U.S. provisional application 61/099,994 filed on Sep. 25, 2008, the disclosure of which is incorporated herein by reference.

### FIELD OF THE INVENTION

The present invention relates to internet search engines, and more particularly to internet search engines that enable a user to perform real time search of chat rooms discussing information defined by one or more key words.

### BACKGROUND OF THE INVENTION AND PRIOR ART

Growth of the internet has yielded innumerable advances in making a massive amount of information accessible and exchangeable. Nevertheless, there is a significant need for better systems and software tools for capturing, organizing, and perusing such information.

Many search engines (Google being currently the most prominent one) offer internet users various ways to search for information over the internet. Commonly, those search engines crawl upon web pages and index them, then let the users find the pages most relevant to the search query by looking for a word or a phrase within a searched page. Whatever the underlying technique is, the end result is this: a user submits a search query and gets in return a list of references to web pages (URLs), where text relevant to the submitted query can be browsed.

This approach has revolutionized the organization of knowledge, making zillions of text pages efficiently indexed and accessible to anybody. Yet this approach has a few drawbacks: sometimes the texts are too long, too complicated, too much to read, too professional or too amateur, too outdated or just too confusing. Sometimes the text is just nearly what you want, but there's still a few questions left unanswered, and there is no one to ask. Nobody is there except robots and texts.

Typically, current search engines index a vast amount of internet sites for potential key words appearing in the sites pages. The indexes are built off-line and are typically updated every few days. When a user performs a search, the search is conducted on the indexed database and hence, the search is not a real-time (RT) search.

On a very different sphere reside internet live chats, starting from internet relay chat and ending with web-based live chat platforms. This is where people (virtually) meet people on the web. A myriad of live chats are taking place every day. Some are for fun and socializing, some focus on professional matters, where you can ask other users and experts just about any question and discuss it. However, the chat platforms and chat rooms are very different from the texts available to search engines. What happens in chat rooms, like in real rooms, is only known to those inside the chat room. The great majority of users outside the chat room can only know that such a chat room exists somewhere, but have, and will have, no access to the chat content.

There is therefore a need and it would be advantageous to have a system and methods that enable a user to perform RT search of chat rooms discussing information defined by one or more key words, provide the user with a list of chat rooms that are currently discussing the information and enable the user to selectively join an ongoing discussion in a particular chat room.

### SUMMARY OF THE INVENTION

The principal intentions of the present invention include providing a system and methods that enable a user to perform real time keyword search and query on live internet chat rooms, provide the user with a list of chat rooms that are currently discussing the information and enable the user to selectively join an ongoing discussion in a particular chat room.

According to the teachings of the present invention there is provided a system facilitating a user to perform a real time search over discussions taking place in chat rooms, the system including a real time (RT) search server having a control manager, a chat rooms database (DB), an indexing engine and an indexed queries DB. The system further includes a robot operatively coupled with a chat room, wherein the robot is configured to collect conversational data from the coupled chat room. The control manager parses the conversational data and stores the parsed conversational data in the chat rooms DB. The indexing engine analyzes and indexes the parsed conversational data and stores the indexed conversational data in the indexed queries DB.

The RT search server further includes a users manager, wherein the users manager parses a search query submitted by a user, indexes the parsed query and stores the indexed query in the indexed queries DB. Preferably, the users manager searches the chat rooms DB thereby returning to the user a linked list of chat rooms matching the indexed query. Optionally, the system further includes a users DB, wherein the users manager store users personal details in the users DB.

An aspect of the present invention is to provide a method for building and/or updating an indexed queries DB, the method including the steps of:
a) providing a RT search server including a control manager, a chat rooms database (DB), an indexing engine and an indexed queries DB;
b) providing a robot operatively coupled with a chat room;
c) collecting conversational data by the robot from the coupled chat room;
d) parsing the conversational data;
e) storing the parsed conversational data in the chat rooms DB;
f) indexing the parsed conversational data; and
g) storing the indexed conversational data in the indexed queries DB.

An aspect of the present invention is to provide a method facilitating performing a real time search over discussions taking place in chat rooms, the method including the steps of submitting a search query by a user, parsing the a search query, indexing the parsed search query, storing the indexed query in the indexed queries DB, searching the chat rooms DB thereby returning a linked list of chat rooms matching the indexed query and providing the user with the linked list of chat rooms.

Optionally, the method facilitating performing a real time search over discussions taking place in chat rooms, further includes the steps of self associating a user with expertise, thereby creating a relevant user, submitting a search query by a querying user, parsing the search query, indexing the parsed search query, searching the chat rooms DB thereby returning a ranked list relevant users, and providing the search query to the highest ranked relevant user in the ranked list relevant users.

### BRIEF DESCRIPTION OF THE DRAWINGS

The present invention will become fully understood from the detailed description given herein below and the accompanying drawings, which are given by way of illustrations and examples only and thus not limitative of the present invention, and wherein:

FIG. 1 is a general schematic illustration of an internet search engine that enables a user to perform real time search of chat rooms system, according to embodiments of the present invention;

FIG. 2 is a detailed example schematic illustration of an internet search engine that enables a user to perform real time search of chat rooms system, according to embodiments of the present invention;

FIG. 3 is an example schematic flow diagram of a method for building and/or updating indexed queries DB of an internet search engine, as shown in FIG. 2; and

FIG. 4 is an example schematic flow diagram of a method for searching chat rooms in real time, according to embodiments of the present invention.

### DETAILED DESCRIPTION OF THE PRESENT INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided to illustrate, so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The methods and examples provided herein are illustrative only and not intended to be limiting.

By way of introduction, the principal intentions of the present invention include providing a system that facilitates searching for subject matters that are the topics of conversations taking place in chat rooms, in real time. Instead of searching an ultra-efficient archive, searching in real time, textual queries in ongoing chats. For example, when searching the web for “pregnancy and birth”, you may stumble upon thousands of medical essays, personal experience descriptions, advices, products, services, you name it. But when searching for chat rooms, the inquirer can finds people discussing “pregnancy and birth” right now and join them.

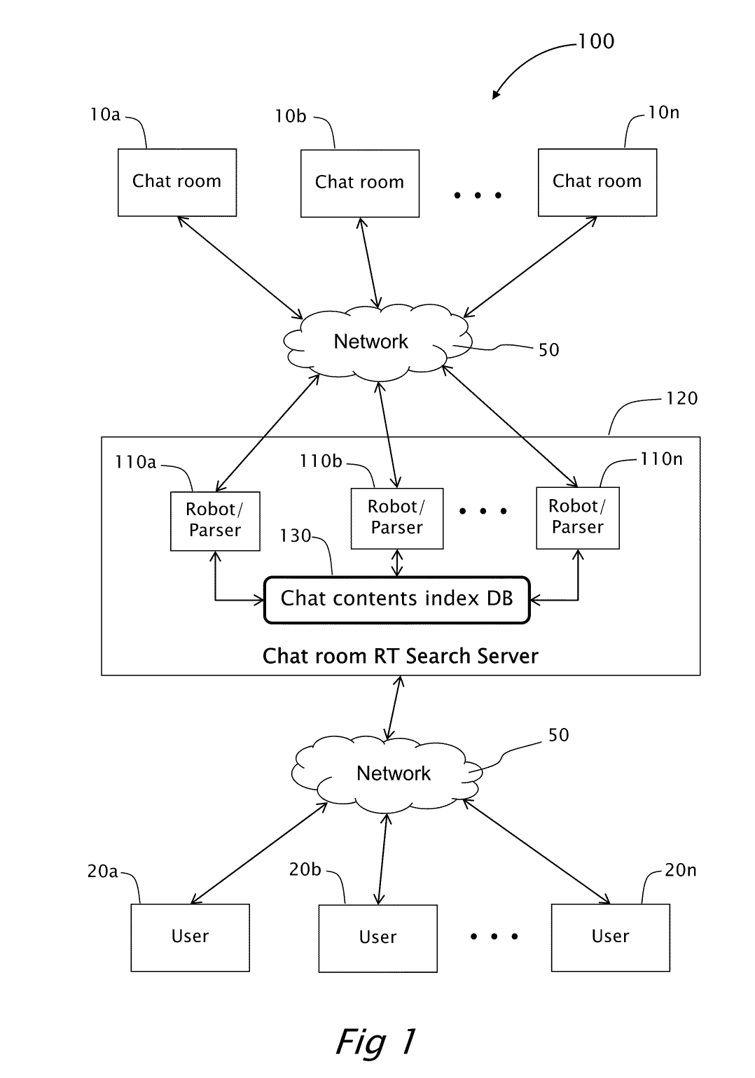

Reference is now made to FIG. 1, which is a general schematic illustration of an internet search engine that enables a user to perform real time search of chat rooms system 100, according to embodiments of the present invention. System 100 includes a server 120 that includes robots 110, each operatively coupled with a particular chat room 10. For example, robot 110a is operatively coupled with chat room 10a; robot 110b is operatively coupled with chat room 10b, etc. It should be noted that system 100 may include more than one server 120. FIG. 1 shows how robots 110, that imitate participating chat room users, log into a chat room 10, “listen” to the dialog inside chat room 10 and pass the conversations data information through a parser to database 130, which parser indexes the data information, whilst internet users 20 connect to the service to search upon the indexed data in database 130.

Chat rooms RT search system 100 is connected to multiple chat rooms 10, via a network 50, in order to identify each available chat room 10 and in order to listen to the conversation taking place in each available chat room 10. Robots 110 log into each respective chat room 10, listens to the conversation taking place and transfer the conversation content to server 120 via a network 50.

Chat rooms RT search system 100 may also be connected to multiple users 20, via a network 50, each of which may submit a search query to server 120, which searches chat rooms 10, identify chat rooms 10 matching the key words and/categories of the search query, and return a linkable list of chat rooms 10, to which user 20 can log into and participate in the ongoing chat. It should be noted that a search query consists of one or more textual words.

It should also be noted that each robot 110 continuously monitors ongoing conversations in the coupled chat room 10. It is not enough to sample chat room 10 once a day or once a week (or any other time interval), as is the case in web pages indexing for textual search engines.

It should also be noted that chat rooms 10 do not have standard format (such as Html/Flash/Ajax/Active-X) as do web pages. Therefore, each robot 110 is required to learn the particular format of the coupled chat room 10.

It should be further noted that chat rooms 10 need to be logged into, which logging-in requires the corresponding robot 110 to learn the login procedure of the coupled chat room 10. The login procedure can be learned at the first time by a human logging in manually and then, teaching the corresponding robot 110 the login procedure. For example, robot 110 is taught the HTTP Get/Post and HTTP Response messages. Once learned the login procedure, robot 110 can repeatably login into the corresponding chat room 10.

Once logged in, robot 110 transfers a detailed list of participants of the ongoing conversation in chat room 10, to server 120. Robot 110 then listens to conversation taking place in corresponding chat room 10, and transfers the conversation content to server 120 via a network 50. Typically, there is a constant exchange between robot 110 and the common server that services chat room 10. Every preset period of time, for example, every 2 seconds, robot 110 sends the server that services chat room 10 an HTTP request message and the server sends back all that was said in chat room 10 since the last HTTP request and so on and so forth. The stream of data coming from the server that services chat room 10 includes also the name or alias of each person and the text that person has entered.

Robot 110 identifies in the data stream, the names and associated text, and sends to server 120 that data and the time stamp of each name and associated text.

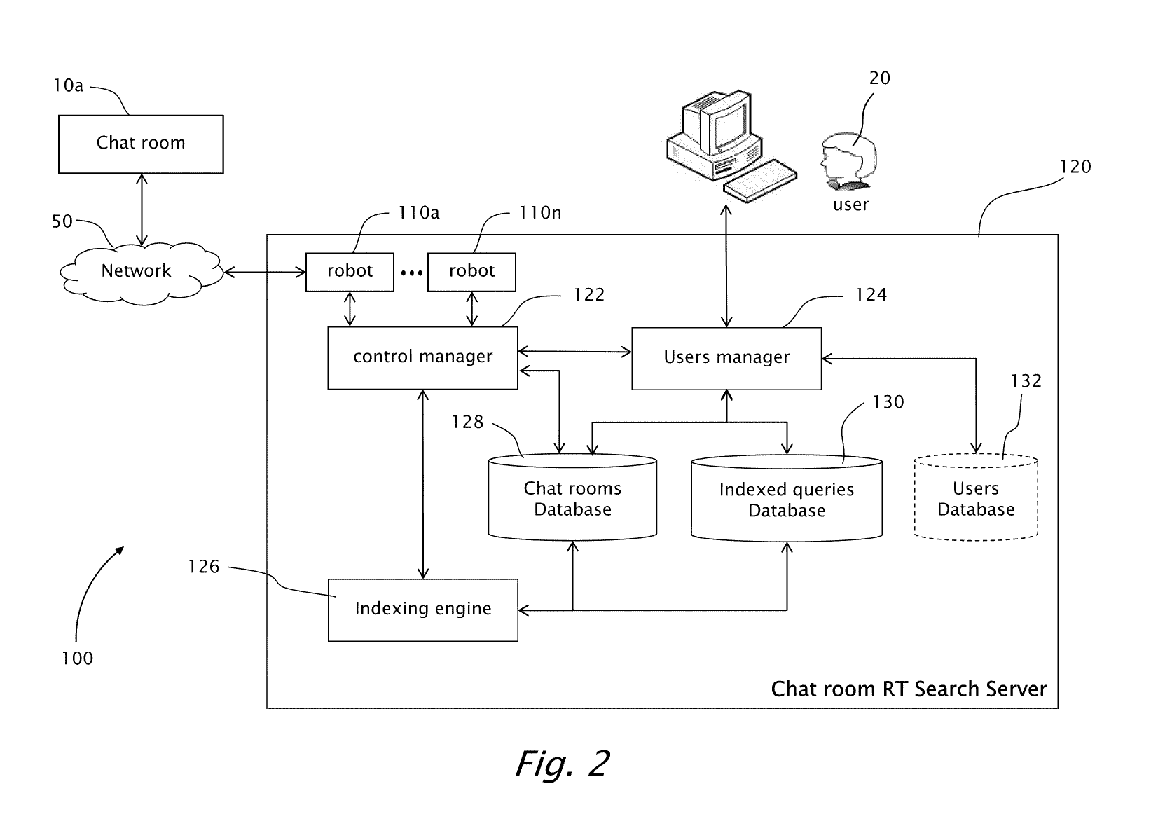

Reference is now made to FIG. 2, which is a detailed example schematic illustration of internet search engine 100. Chat room RT search server 120 includes control manager 122, users manager 124, chat rooms database (DB) 128 indexed queries DB 130 indexing engine 126 and optionally, users DB 132.

The list of participants and data segments containing {time, the name of the speaker, text} arrives at control manager 122 of server 120. Control manager 122 stores each data segment at the storage segment associated with robot 110, in chat rooms DB 128.

Preferably, each data segment is analyzed by indexing engine 126, categorized into relevant categories and the indexed data is stored in indexed queries DB 130. For example, the word “daisy” can be categorized into category “flower” as well as into category “nature” or any other relevant category. To facilitate real time or near real time search of information being discussed in multiple chat rooms 10, indexing engine 126 indexes the data stored in chat DB 128 and stores the indexed data in DB 130. Near real time search meaning that data currently flowing in from chat rooms 10, may not have been indexed as yet, and thereby there is a delay of a few minutes from being pure real time search.

When a user 20 submits a search query, the request is analyzed and handled by users manager 124 and the search is conducted on indexed data in DB 130. Users manager 124 parses a search query submitted by a global user 20, indexes the parsed query and stores the indexed query in the indexed queries DB 130.

The search process returns a report containing a list of chat rooms 10 discussing the subject matter defined in the user's search query. Typically, the report also includes data segments containing the subject matter defined in the search query, the name associated with each data segment and weather the discussion is still active or was terminated.

In variations of the present invention, data segments recently and/or currently flown into server 120 from one or more selected chat rooms 10, by the respective robot 110 of the selected chat rooms 10, are directly presented to user 20.

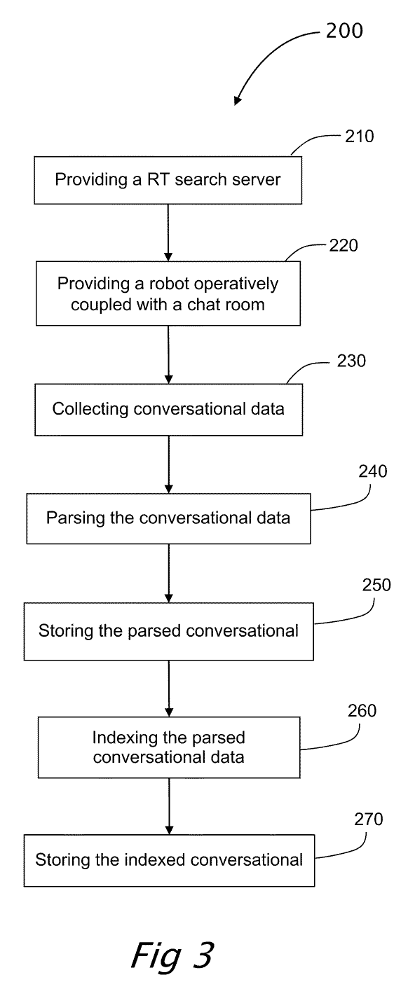

Referring now to FIG. 3, an example schematic flow diagram of a method 200 for building and/or updating indexed queries DB 130, according to embodiments of the present invention, is provided. A chat rooms RT search server 120 is provided (step 210) and robots 110 are operatively coupled (step 220) with each chat room 10. Method 200 includes the following steps:

Step 230: collecting conversational data.

Each robot 110 collects conversational data from the coupled chat room.

Step 240: parsing the conversational data.

Each collected data segment is parsed by indexing engine 126.

Step 250: storing the parsed conversational.

The parsed conversational data is stored in chat rooms DB 128.

Step 260: indexing the parsed conversational data.

The parsed conversational data is indexed and categorized into relevant categories by indexing engine 126.

Step 270: storing the indexed conversational.

The indexed data is stored in indexed queries DB 130.

An aspect of the present invention is to further provide a link to each chat room 10, and thereby enable a global user 20 to login and enter chat room 10. It should be noted that if user 20 decides to login into a particular chat room 10, since the corresponding robot 110 already knows the login procedure of that chat room 10, robot 110 can create a name for user 20 and perform the login procedure into chat room 10 for user 20. Alternatively, if user 20 is a registered user (which personal details are optionally stored in DB 132), robot 110 can automatically perform the login procedure for user 20 into chat room 10.

An aspect of the present invention is to enable user 20 to submit a question or a request to a particular participant of a particular chat room 10. According to such variation of the present invention, user 20 can chat with a particular participant of a particular chat room 10, without having to log into that chat room 10. Server 120 first checks that user 20 is a registered user of that particular chat room 10 and if not, server 120 can automatically register user 20 to the particular chat room 10. Furthermore, system 100 enables user 20 to chat with particular participants of a multiple number of chat rooms 10, providing user 20 with a special display page with all the relevant data to enable user 20 to follow each of conversations in which he is engaged.

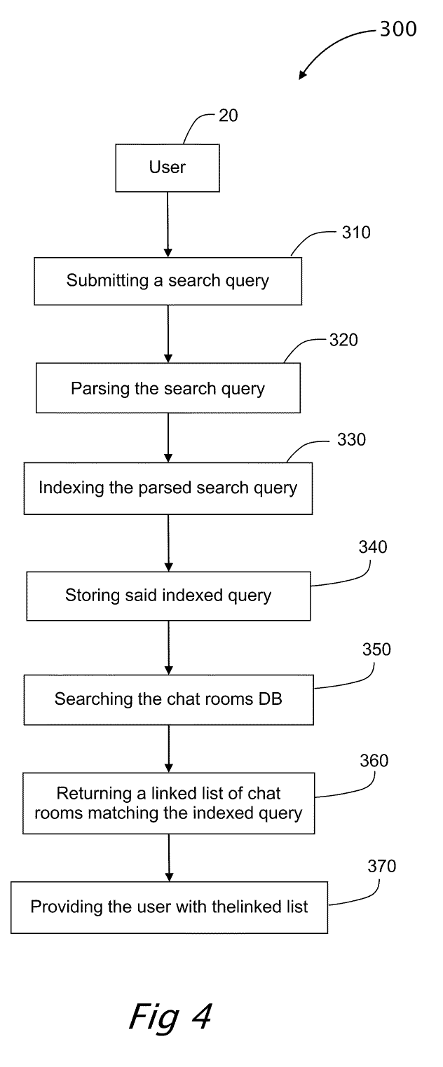

Referring now to FIG. 4, an example schematic flow diagram of a method 300 for searching chat rooms 10 in real time, according to embodiments of the present invention, is provided. A user 20 logs into chat rooms RT search server 120 and submits a search query (step 310). Method 300 includes the following steps:

Step 320: parsing the search query.

Users manager 124 parses the search query submitted by global user 20.

Step 330: indexing the parsed search query.

Users manager 124 indexes the parsed query.

Step 340: storing the indexed query.

The indexed query is stored in the indexed queries DB 130.

Step 350: searching chat rooms DB 128.

Users manager 124 searches chat rooms DB 128 for a matched text data segment.

Step 360: returning a linked list of chat rooms matching the indexed query.

All matched text data segments are arranged in a list, whereas each matched text data segment is coupled with the chat room 10 in which the matched text data segment was said.

Step 370: providing the user with the linked list.

User 20 that submitted the search query is provided with the linked list formed in step 360.

The term “relevant user” as used herein refers to a user 20 who has registered as being an expert in a particular field or whether he/she is in a specific chat room 10 with a particular main theme such as: astronomy, entertainment, sport, etc.

In variations of the present invention, system 100 also includes an instant message module version, which a non-registered user may download to the user's computerized platform and interact with other users connected to system 100. When a user 20 registers to system 100, user 20 may also enter his/her main fields of knowledge and/or interest such as sports, computers, etc., and thereby becomes a “relevant user” in the listed fields. The expert user 20 may then get relevant questions from other users (registered or non-registered), according to the user's 20 field of expertise. System 100 breaks down the request sentence/question into key words semantics and/or categories identified in the search query, which query is then sent to a relevant user.

In variations of the present invention, chat-rooms search engine 100 is facilitated to search other internet-based chat enabled systems, such as MS Messenger. The present invention is not limited to chat rooms and messenger, and other voice over IP systems can be searched.

In variations of the present invention, users 20 are provided with an appropriate toolbar for ease of access to the service of RT search of chat rooms 10.

In variations of the present invention, the search engine can be adaptively fitted to various groups of users, such as salesmen, law enforcement personal, finance people such as banks and brokers, etc.

In variations of the present invention, a method facilitating a prize winning contest is provided. The method includes the steps of presenting a participating user 20 of system 100 a trivia question, for which user 20 has a limited time to answer, for example, 30 seconds. Preferably, user 20 is a relevant user. System 100 may charge a game participating fee from participating user 20. Optionally, if participating user 20 fails to provide the correct answer, the winning prize is incremented. The trivia question is then presented to another participating user 20. Upon providing the correct answer to the trivia question by a participating user 20, the winning participating user 20 receives the accumulated prize. Optionally, System 100 may charge a percentile of the prize or any other winning fee.

The invention being thus described in terms of several embodiments and examples, it will be obvious that the same may be varied in many ways. Such variations are not to be regarded as a departure from the spirit and scope of the invention, and all such modifications as would be obvious to one skilled in the art.

What is claimed is:

1. A system facilitating a user to perform a real time search over discussions taking place in chat rooms, the system comprising:
a) a real time (RT) search server comprising:
i) a control manager;
ii) a chat rooms database (DB);
iii) an indexing engine; and
iv) an indexed queries DB, and
b) a robot operatively coupled with a chat room,
wherein said robot is configured to collect conversational data from said coupled chat room;
wherein said control manager parses said conversational data and stores said parsed conversational data in said chat rooms DB; and
wherein said indexing engine analyzes and indexes said parsed conversational data and stores said indexed conversational data in said indexed queries DB.

2. The system of claim 1, wherein said RT search server further comprises:
v) a users manager,
wherein said users manager parses a search query submitted by a user, indexes said parsed query and stores said indexed query in said indexed queries DB.

3. The system of claim 2, wherein said users manager searches said chat rooms DB thereby returning to said user a linked list of chat rooms matching said indexed query.

4. The system of claim 2, wherein said system further comprises:
c) a users DB,
wherein said users manager store users personal details in said users DB.

5. The system of claim 1, wherein said chat room is any voice over IP system.

6. A method facilitating performing a real time search over discussions taking place in chat rooms, the method comprising the steps of:
a) providing a RT search server comprising:
i) a control manager;
ii) a chat rooms database (DB);
iii) an indexing engine; and
iv) an indexed queries DB;
b) providing a robot operatively coupled with a chat room;
c) collecting conversational data by said robot from said coupled chat room;
d) parsing said conversational data;
e) storing said parsed conversational data in said chat rooms DB;
f) indexing said parsed conversational data; and
g) storing said indexed conversational data in said indexed queries DB.

7. The method of claim 6 further comprises the steps of:
h) submitting a search query by a user;
i) parsing said search query;
j) indexing said parsed search query;
k) storing said indexed query in said indexed queries DB;
l) searching said chat rooms DB thereby returning a linked list of chat rooms matching said indexed query; and
m) providing said user with said linked list of chat rooms.

8. The method of claim 6 further comprises the steps of:
h) self associating a user with expertise, thereby creating a relevant user;
i) submitting a search query by a querying user;
j) parsing said search query;
k) indexing said parsed search query;
l) searching said chat rooms DB thereby returning a ranked list relevant users; and
m) providing said search query to the highest ranked relevant user in said ranked list relevant users.

9. The method of claim 6 further comprises the steps of:
h) presenting a user with a trivia question;
i) providing a winning prize for answering said trivia question;
j) limiting the time for responding to said trivia question; and
k) upon receiving a correct answer, awarding said user with said winning prize.

10. The method of claim 9 further comprises the steps of:
l) upon receiving an incorrect answer, incrementing said winning prize.

11. The method of claim 10 further comprises the step of:
m) presenting a another user with a trivia question;
n) limiting the time for responding to said trivia question; and
o) upon receiving a correct answer, awarding said another user with said winning prize.

12. The method of claim 9 or 11 further comprises the step of:
h) charging said user with a game participating winning fee.

13. The method of claim 9 or 11 further comprises the step of:
i) charging said user with a winning fee.
